(19) United States
(12) Patent Application Publication
(10) Pub. No.: US 2002/0001032 A1
(43) Pub. Date: Jan. 3, 2002

(54) PORTABLE COMPUTER, DATA MANAGEMENT SYSTEM USING THE SAME, AND METHOD OF PRODUCING A MAP STORED WITH ACTUAL PHOTO-IMAGE DATA USING THE SAME PORTABLE COMPUTER AND DATA MANAGEMENT SYSTEM

(75) Inventor: SINJI OHKI, OSAKA (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(73) Assignee: Nippon LSI Card Co., Ltd., Osaka (JP)

(21) Appl. No.: 08/902,011

(22) Filed: Jul. 29, 1997

(30) Foreign Application Priority Data
Nov. 15, 1996 (JP) H08-304553

(51) Int. Cl. H04N 5/217

(52) U.S. Cl. 348/207; 348/241

(57) ABSTRACT

The present invention provides a portable computers capable of facilitating management of actual photo-image in association with each other, thereby remarkably expanding the application range of the actual phot-image data. The portable computer is connectable directly or through a memory medium to the main computer in a fixed base. The portable computer comprises: a digital camera detachably provided for successively taking actual photo-images; position specifying identification data setting means for setting identification data to specify at least one of photographing related positions consisting of a position of an object for photography taken by said digital camera and a position where photography was taken by said digital camera; and actual photo-image data memory means for storing the identification data set by said position specifying identification data setting means in association with actual photo-image data outputted from the digital camera.

### BACKGROUND OF THE INVENTION

1. Field of the Invention

The present invention relates to a portable computer detachably equipped with a digital camera, and to a data management system using the same. The present invention also relates to a method of producing a map stored with actual photo-image data using the same portable computer and data management system.

2. Description of the Related Art

In recent years, as a means for capturing photo-images into a personal computer (hereinafter referred to as PC), digital cameras are widely used which mainly consist of a CCD (charge coupled device), a lens unit, and a memory means for storing a plurality of photo-image data which have been taken. However, this type of digital camera has a very limited function such as simply storing photographed images into a memory means as photo-image data, successively. Therefore, the photo-image data taken by the digital camera are generally captured onto the PC, where the photo-images are stored therein while reviewing the photo-images on the display of the PC and giving an appropriate file name to each photo-image. However, in the case where the photo-image data are managed with simple file names only, there arise such problems that the more the number of files increases, the more management thereof becomes complicate, and the association of the photo-images with each other becomes less, with a result that a necessary file cannot be taken out quickly.

### SUMMARY OF THE INVENTION

In view of the above, an object of the present invention is to provide a potable computer and a data management system using the same, which enable easy management of actual photo-images and also enable the management of the actual photo-image data in association with each other, to thereby remarkably expand the application range of the actual photo-image data which have been produced. Further, the present invention has another object of the invention to provide a method of producing a map stored with the actual photo-image data using the same portable computer and data management system. More specifically, the present invention is directed to provide a map stored with actual photo-image data through which the surrounding conditions of the position to be seen may be more specifically and realistically grasped, by setting a plurality of positions such as a position of an object for photography and a position where a photograph is taken by a digital camera (hereinafter referred to as photographing related positions), on the map displayed on the display means, by specifying a desired photographing related positions using a cursor or the like, and by switchably and dividably displaying the actual photo-image on the display, and the method of producing the same using the portable computer and the data management system using the same.

According to the present invention, there is provided a portable computer which is connectable directly or through a memory medium to the main computer in a fixed base, and comprises: a digital camera detachably provided for successively taking actual photo-images; position specifying identification data setting means for setting identification data to specify at least one of photographing related positions consisting of a position of an object for photography taken by said digital camera and a position where photograph was taken by the digital camera; and actual photo-image data memory means for storing the identification data set by the position specifying identification data setting means in association with the actual photo-image data outputted from the digital camera.

Therefore, according to the portable computer of the present invention, for example, by taking a photograph of a street scene by a digital camera and by setting an identification data for specifying a photographing related positions by the position specifying identification data setting means, it becomes possible to associate an actual photo-image data with the identification data with each other on the spot where photograph is taken, to thereby facilitate the management of the actual photo-image data. Further, in case of using as the identification data maps, positions on a drawing, residential addresses, phone numbers, or the like, the mutual relevance among the respective actual photo-image data is enhanced, thereby enabling to take out necessary the actual photo-image data with ease based on the identification data, and to remarkably expand the application range of the actual photo-image.

Further, since the portable computer according to the present invention include as the position specifying identification data setting means base data memory means for storing a map or drawing data including at least the photographing related positions and display means for displaying the same, a present position or the like may be grasped based on the map or drawing data displayed on the display means without carrying the map or the like. Still further, the portable computer according to the present invention is provided with an input means for inputting the photographing related positions through the map or drawing data displayed on the display means, and therefore it is possible to specify the photographing related positions on the map or drawing displayed on the display means by operating a cursor of the input means, with a result that the position data on the map or drawing may be used with ease as the identification data. Furthermore, since the position specifying identification data setting means includes a GPS adaptor for measuring an absolute position by using a communication satellite, the present position may be readily grasped. Also, the photographing position is used as the photographing related position, the data of the present position outputted from the GPS adaptor may be automatically captured as it is as the identification data. Further, even in the case where the position of an object for photography is used as the photographing related position, it enables to readily set a present position outputted from the GPS adaptor as the identification data by the fine adjustment of the present position. Furthermore, an address of an actual photo-image data storing position in the memory of the main computer may be set as an identification data.

Furthermore, a portable computer according to the present invention is provided with a measuring means for measuring a physical quantity relating to at least one environmental condition selected from temperature, humidity, noise level and illumination at the time of photographing, and measured data outputted from said measuring means are stored in association with the actual photo-image data into said actual photo-image data memory means, thereby being capable of displaying in such a manner that the surrounding circumstances at the position of photographing may be grasped.

Still further, a portable computer according to the present invention includes a laser light irradiating means for irradiating a laser light to an object for photography. In this case, for example, the laser light irradiating means are provided on the respective three apexes of regular triangle, and three laser lights are irradiated to the object for photography in parallel to the photograph direction upon photographing. Therefore, even in the case where the object for photography is photographed from a slanting position, it is possible to obtain substantially the same image as the one taken from the front position by correcting the actual photo-image in such a manner that the laser light irradiation point displayed on the actual photo-image is moved to the apex of the regular triangle. Also, if a distance among each laser light is preset, the size of the object for photography may be obtained from the actual photo-image. Incidentally, the laser light having a relatively large round irradiation point is irradiated to the object for photography, and the actual photo-image may be corrected to have a similar round irradiation point on the photographed actual photo-image.

A data management system according to the present invention is provided for storing the actual photo-image data outputted from a digital camera when taking the actual photo-images using the digital camera, in association with identification data for specifying photographing related positions into actual photo-image memory means, successively. As described above, since the actual photo-image data may be stored in associated with the identification data at the place where photograph was taken, management of the actual photo-image data is facilitated. Further, in case of using as the identification data maps, positions on a drawing, residential addresses, phone numbers, or the like, the mutual relevance among the respective actual photo-image data is enhanced, thereby enabling to take out necessary actual photo-image data with ease based on the identification data, and to remarkably expand the application range of the actual photo-image.

A method of producing a map stored with actual photo-image data according to the present invention comprises the steps of: transporting a portable computer as described in any one of a first to seventh aspects of the invention, to the position where a photograph is taken; taking actual photo-images which can be viewed from the position where photographs are taken using a digital camera detachably provided with the portable computer; and storing the actual photo-image data outputted from the digital camera in association with position data on drawing data as identification data for specifying photographing related positions.

As described above, since the actual photo-image data is stored in association with the position data on the map or the drawing data, the actual photo-image of the object for photography at the specified photographing related positions may be realistically grasped, by specifying the photographing related positions set on the map. Further, if such a map stored with an actual photo-image data is stored into a memory medium such as a CD-ROM or DVD (digital video disks), it enables to utilize the map for those in car navigation systems, or as an appendix of a town magazine, etc., for introducing restaurants and play spots, or for recording chronological change of sights on the street for verification.

Further, according to a method of producing a map stored with live photo-image data of the present invention, the method comprises: taking a plurality of actual photo-images using the digital camera so as to overlap the respective adjacent side end portions with each other; and subjecting a data processing such as cutting the overlapped portions of the actual photo-images on a main computer after transferring the actual photo-image data directly or via a recording medium from the portable computer to the main computer, thereby being capable of capturing a scenes on the street, etc., as the successive photo-image.

Furthermore, according to a method of producing a map stored with actual photo-image data, the method further comprises: using a digital camera with wide-angle lens as a digital camera; and a step of subjecting a correction processing to the wide-angle actual photo-image data outputted from the digital camera for correcting distortions of photo-image due to the wide-angle lens, thereby being capable of substantially compressing the actual photo-image data by enlarging the photographing area of one actual photography.

### BRIEF DESCRIPTION OF THE DRAWINGS

FIG. 1 is a drawing illustrating an external appearance of the portable computer according to the present invention;

FIG. 2 is a system structural drawing of the portable computer according to the present invention;

FIG. 3 is a flowchart showing each data processing processed by hardware or software in the main body of the portable computer;

Fog. 4 is a drawing illustrating one example of a structure inside a digital camera adaptor;

FIG. 5 is a drawing illustrating another example of a structure inside the digital camera adaptor;

FIG. 6 is a drawing illustrating a step A of a recording method of a position for photography according to the present invention;

FIG. 7 is a drawing illustrating a step B of the recording method of the position for photography according to the present invention;

FIG. 8 is a drawing illustrating a step C of the recording method of the position for photography according to the present invention;

FIG. 9 is a drawing illustrating a step D of the recording method of the position for photography according to the present invention;

FIG. 10 is a drawing illustrating a step E of the recording method of the position for photography according to the present invention;

FIG. 11 is a diagram showing an actual method of photography;

FIG. 12 is a diagram showing another method of photography;

FIG. 13 is a drawing illustrating a step F of the recording method of the position for photography according to the present invention;

FIG. 14 is a drawing illustrating a use method of a map stored with an actual photo-image data by a personal computer; and

FIGS. 15A and 15B are diagrams showing how the actual photo-image is corrected into a frontal view or the like.

### DESCRIPTION OF THE PREFERRED EMBODIMENT

Description will now be made in detail of an embodiment of the present invention with reference to the drawings.

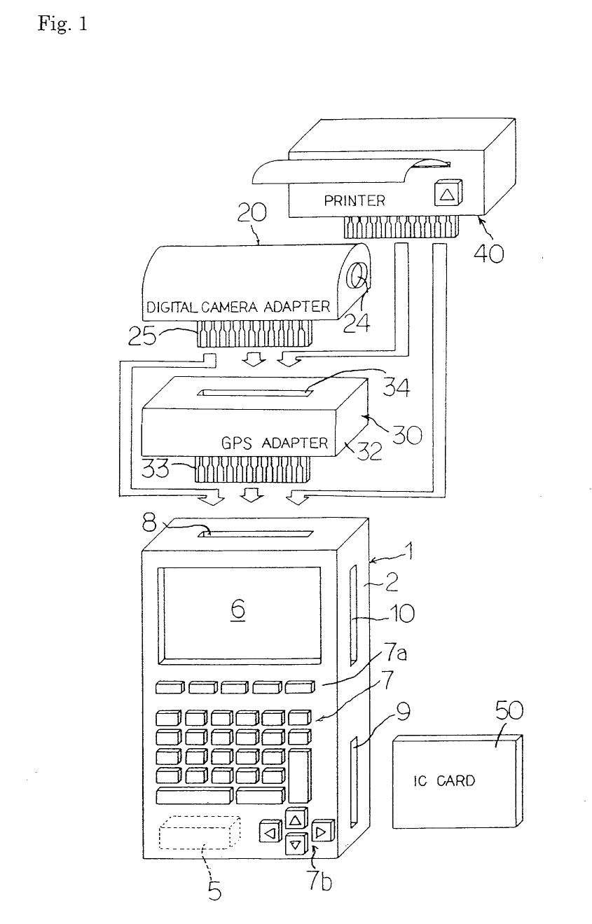

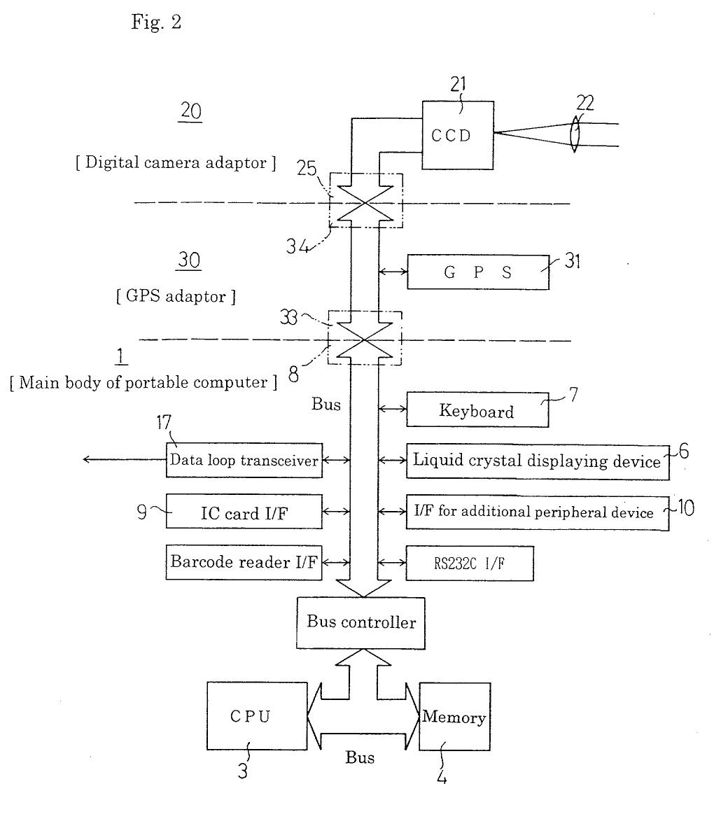

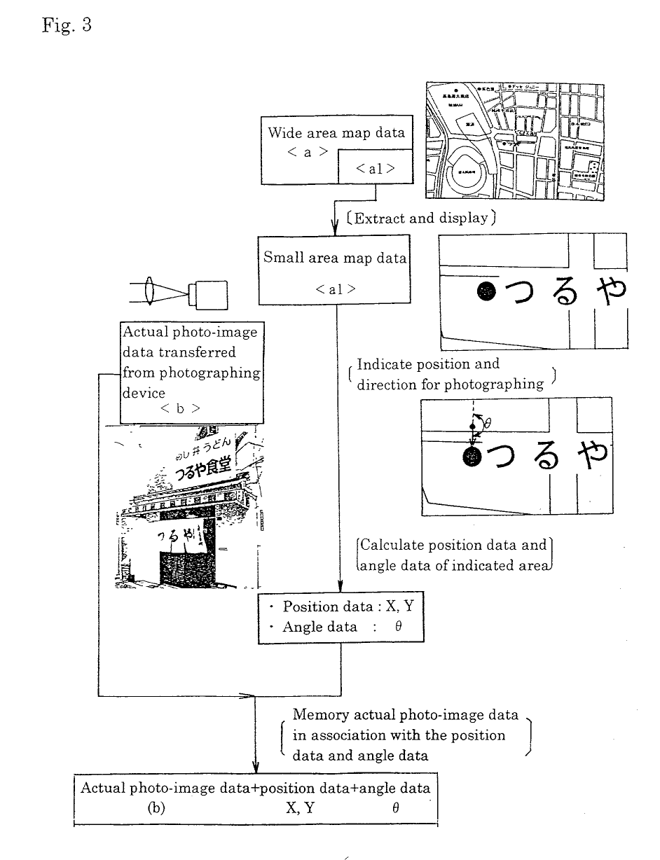

FIG. 1 is a drawing illustrating an external appearance of the portable computer according to the invention; FIG. 2 is a system structural drawing of the portable computer; FIG. 3 is a flowchart showing each data processing processed by hardware or software in the main body of the portable computer.

In FIG. 1, reference numeral 1 denotes a main body of a portable computer, and 20 denotes a digital camera adaptor for the portable computer (will be called hereinafter as digital camera adaptor 20) while 30 denotes a GPS adaptor.

The main body of the portable computer 1 is a consolidation of all the basic functions of the computer housed into a main body case 2 that is built in compact dimensions so as to be carried with a single hand. The main body case 2 has therein a microprocessor 3, a memory 4, various control circuits, and a portable inner power source 5 such as dry cells and rechargeable batteries. On the outer surface of the main body case 2, there is provided a display device 6 which is thin and low power consuming like a liquid crystal or plasma display and which allows a graphic display by dot, and a keyboard 7 as input means having function keys 7a and cursor moving keys 7b. Although not shown in FIG. 1, data entry system by a pen may be also employed as input means in place of a keyboard input system, or a combination of keyboard entry and pen entry. In this portable computer 1, the input means or the GPS adaptor 30 corresponds to the position specifying identification data setting means.

On the top of the main body case 2, there are bus connecting terminals 8 connectable direct to the microprocessor 3. Also, various peripheral devices such as the GPS adaptor 30, the digital camera adaptor 20, a printer 40 or a MODEM (not shown) are connectable to the bus connecting terminals 8. Although the bus connecting terminals 8 are female connecters in this embodiment, male connecters may be used instead thereof.

On one side of the main body case 2, there is provided an IC card interface 9 for inserting an IC card 50 as one of the external memory means. Further, on the same side of the main body case 2, there is provided another interface 10 for additional peripheral devices such as a floppy disk drive (FDD), a hard disk drive (HDD), a CD-ROM, and a rewritable magneto-optical disk drives (MO) to be taken in. The IC card 50 may be either of the one carrying a CPU inside or the one without CPU. While the mode of its coupling with the portable computer 1 may be of a pin-contact type or of a contactless type, the use of the latter is more preferable when considering superiority in dust-proof, anti-shock and handling facility.

There are cases where no IC card interface 9 nor interface 10 for additional peripheral devices are to be installed, while either one of them may be installed in the main body case 2. Although being not shown, an RS232C interface for connecting general purpose MODEMs, and a bar code reader interface may be installed.

The display device 6 is so designed as to enable a monitoring of present photographing conditions or to play-back display on its screen of the actual photo-image data taken into the memory 4, drawing or map data taken out of the IC card 50, FDD or via a cable, or displaying directly output of image signals from a CCD 21 of the digital camera.

Since it is possible to confirm the present photographing conditions on the display device 6 of the main body of the portable computer 1, photo images may be taken in under optimum conditions by adjusting photographing area, tints of colors and resolutions while watching display screen. Adjustment of image tints and resolutions may be done by hardware, providing separate adjustment circuit. However, adjustment process by a software is more desirable in view of multi purposes and of a joint work with the microprocessor 3. Adjustment of image tints may also be conducted by thinning out color dots at predetermined intervals or by compressing image data by a competent software.

Display of images is so composed that it is possible to switch the screen photo images from the data taken out of IC card 50 and FDD and stored into the memory 4 to the actual photo-image data being presently taken by an image capturing unit. Multiples of images in partitions can also be displayed on the same screen, simultaneously.

Programs for image processing can either be loaded permanently in the memory 4 or taken out of IC card 50 or FDD whenever necessary. Permanent loading of programs in the memory 4 may be done by writing them into its ROM or non-volatile memories such as a flash memory, or having loaded outside programs into its RAM.

In this embodiment, a part of the memory 4 is non-volatilized using a flash memory and into such part programs for image adjustment may be stored together with operation programs for specific purposes. Since permanent programs loaded on the flash memory can be upgraded whenever necessary by programs taken out of IC card 50 and FDD, though a common portable computer can be used, an exclusively designed portable computer for specific purposes can be provided, still maintaining flexibility to correspond to the upgrade of programs.

The digital camera adaptor 20 is so structured as to be mounted either directly or detachably with GPS adaptor 30 interposed therebetween on the top of the portable computer 1.

As shown in FIG. 4, the digital camera adaptor 20 has a structure in which an image capturing unit consisting mainly of a CCD 21 and a lens 22 for forming a photo image on the CCD 21 are housed into an adaptor case 23. On the one side of adaptor case 23, there is a round opening 24 for passage of light to the lens 22, while on the bottom of the adaptor case 23 are provided male bus connecting terminals 25 corresponding to the bus connecting terminals 8 provided in the portable computer 1.

The opening 24 is covered by a transparent plastic plate and a lens, which are to be coupled with a lens 22 inside the adaptor case 23, thus forming a passage of light to the CCD 21. While the lens 22 and the lens covering the opening 24 may be made of either glass or plastics, those made of plastics are more preferable in view of reducing weight and cost. There may be added such a function as the lens sliding back and forth in order to realize better focusing. Also, a single lens attached direct to the opening 24 will serve reduction of components. Furthermore, the CCD 21 and lens 22 may be coupled into a single component for photographing. The position for forming the opening 24 is not limited to the exact position shown in the figure, but it may be anywhere either on the top or backside of the adaptor case 23.

The CCD 21, the lens 22 and some of the elements 26 are directly mounted on a single substrate 27 on the positions where axis of light connecting the CCD 21 and the lens 22 runs on the same passage where light comes in through the opening 24 of the adaptor case 23. One end of a multi-core flat cable 28 is leaded out and attached to the substrate 27, with the other end connected to the male bus connecting terminals 25 (not shown). Since all of the main electric and optical components are mounted on a single substrate 27, it is easy to assemble the digital camera adaptor 20 with less assembling cost.

A host of elements 26 are mounted on the board 27, but the number of the host of elements 26 is reduced to a minimum so as to match output signals from CCD 21 on the buss line. There is no microprocessor or memory mounted on the board 27.

Output signals of photo image from CCD 21 are entered, through the bus line, directly into the microprocessor 3 of the main body of the portable computer 1 in which these signals are processed in the main body of the portable computer 1 to be displayed on a display device 6. Power to the digital camera adaptor 20 is supplied by the main body of the portable computer 1 through the buss line. Thus, using the minimum number of components for the digital camera adaptor 20 makes it possible to provide the digital camera adaptor 20 at very reasonable price.

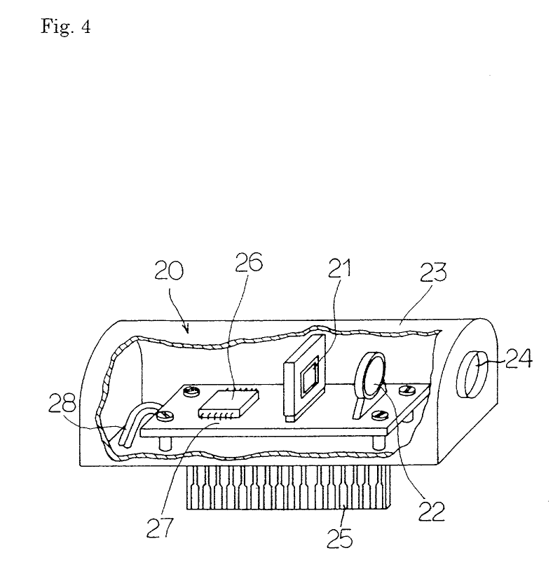

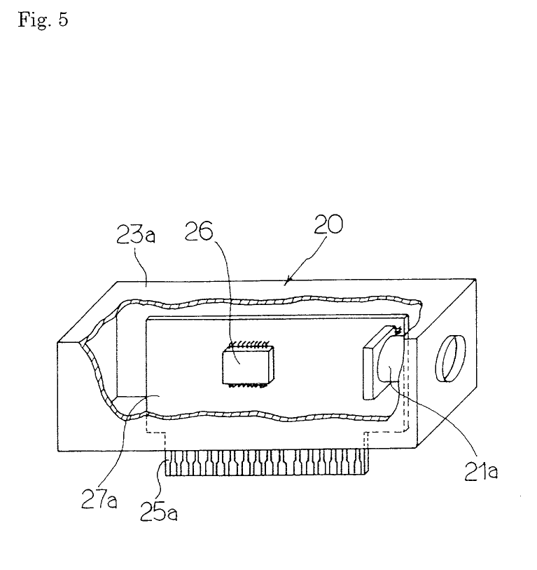

FIG. 5 shows the interior structure of the digital camera adaptor 20 according to another embodiment of the invention. In this embodiment, the one side of a substrate 27a is directly molded into a pattern by etching the connecting terminals, on which the substrate 27a an integrated image photographing component 21a consisting of a CCD and a lens is to be mounted. The substrate 27a is kept standing inside the adaptor case 23a while the etched connecting terminals are extruded outside the adaptor case 23a to be used straightly as male bus connecting terminals 25a. By applying such a structure, there will be no need of adding bus connecting terminals on to the adaptor nor using multi-core flat cables for connection, so that the number of assembling process can be reduced to a greater extent. Although an integrated image photographing component 21a is used wherein a CCD and a lens are integrated, a CCD and a lens can of course be provided as separate parts.

The GPS adaptor 30 has a built-in GPS 31 which is a device for specifying an absolute position by using communication satellites known as Global Positioning System. On the exterior of a case 32 storing GPS adaptor 30, there are male bus connecting terminals 33 and female bus connecting terminal 34. The male bus connecting terminals 33 are connectable to the bus connecting terminals 8 of the main body of the portable computer 1, while the female bus connecting terminals 34 are so composed as to be connected with the digital camera adaptor 20 and a printer 40.

By receiving positional data signals from communication satellites, GPS 31 is capable of measuring the present position of the observer within a tolerance of a few meters, making it easier for the observer, i.e., photographer, to identify his (or her) present position by transmitting the position data to the main body of the portable computer 1. Therefore, it is particularly preferable to have this portable computer equipped with the GPS adaptor 30 whenever it is to deal with map data. However, the GPS adaptor 30 is not required when it is to deal with other data such as architectural drawings and house plannings. In this case, the portable computer 1 is equipped with a digital camera adaptor 20 and/or a printer 40 through the bus connecting terminals 8 of the main body of the portable computer 1.

The interior of a portable computer having the above-described hardware is composed of means for executing every one of the processes shown in FIG. 3 running both on software and hardware. Here is an example of producing a map stored with actual photo-image data, using the portable computer 1. The first step is to store flat map data into the memory 4 for capturing the actual photo-images at a plurality of positions on the map data. The second step is to obtain an identification data such as position data on the map at point (X, Y) where photograph is taken, and photographing angle data θ showing clockwise deviation of angles from north being the standard position. This identification data are to be stored into the memory 4 in association with the captured actual photo-images. In addition, it is also possible to make survey of the work position by storing into the memory 4 house planning maps or architectural drawings in association with the actual photo-images and positions where photograph is taken. Also, it is possible to store a position data (X, Y) of an object for photography on the map as an identification data in association with actual photo-images.

There is provided a memory means 11 for storing map data <a>on the intended position where photograph is taken, and surrounding area. The memory means 11 may preferably be in large capacity enough to store map data of relatively large area including positions for photography. The memory means 11 is usually composed of a part of memory 4. The map data <a>may either be in vectors or in photo-images.

A selectively display means 12 is provided for calling selectively map data in selected small area <a1>including an exact position for photography from map data <a>stored in memory means 11 (i.e., wide-area map data <a>), and for displaying the image of <a1>on the display device 6.

For extracting small area map data <al>from map data of surrounding area <a>, it is proposed to show the map data of surrounding area <a>on the display device 6 and scroll a cursor on the display 6 by cursor moving keys 7b to the position nearest to the photographing position and then press a function key for area shifting (not shown), or to point out directly, by a pen inputting device, the position nearest to the position for photography. It may be also proposed to laminate a pressure sensitive sensor panel for specifying the coordinate of the screen on the front surface of the display screen, so as to press the desired position. In addition, only small area map data <a1>may be displayed on the display device 6, thereby moving the image either by switching or scrolling on the screen.

An indicating means 13 for specifying a photographing position is provided for specifying on the screen both the position and direction of the photography out of small area map data <a1>shown on the display device 6. For instance, when photographing scenes on the other side of the street from the position where a photographer is standing, the photographer will move a cursor 14 to his (or her) present position in the small area map data <a1>shown on the display screen and press an enter key or the like after specifying the direction for photography. Also in this case, a pen inputting device or a pressure sensitive sensor panel may be used. Furthermore, when the portable computer 1 is equipped with the GPS adaptor 30, it is possible to readily display the present position on the screen of the display device 6 based on a position data from the GPS adaptor 30, and then press the enter key after moving the cursor 14 to the photographing position where the photographer is to specify the direction for photography. With a GPS adaptor 30 equipped, it is also possible to show automatically small area map data <a1>on the screen. The direction for photography may be obtained by using a gyrocompass or a similar device for a manual key entry to the portable computer, while automatic detection may also be achieved by addition of the gyroscope to the portable computer. In the case of photographing sequently scenes on the street, positions and directions for photography may be predetermined on the display so that the execution key may be pressed whenever the cursor moves to the photographing position.

A position data calculating means 15 is provided for calculating position data X, Y on the position specified on the map shown on the display device. The actual calculation is conducted by the microprocessor 3.

Furthermore, a relative memory processing means 16 is provided wherein the actual photo-image data <b>at the position for photography, obtained by an image capturing unit, is stored into a memory in association with the above-described position data X, Y and photographing angle data θ. The actual photo-image data <b>, the position data X, Y and the angle data θ may be stored into the memory put together, while these data may be kept stored in separate memory areas with connecting strings between each data. With actual photo-image data <b>and position data X, Y corresponding to each other, it is always possible to recognize which portion of the map data <a>each actual photo-image data <b>corresponds to. Instead of using position data, it is also possible to store into a memory such identification data as an address of actual residence or address on the memory of the main computer in association with the actual photo-image data.

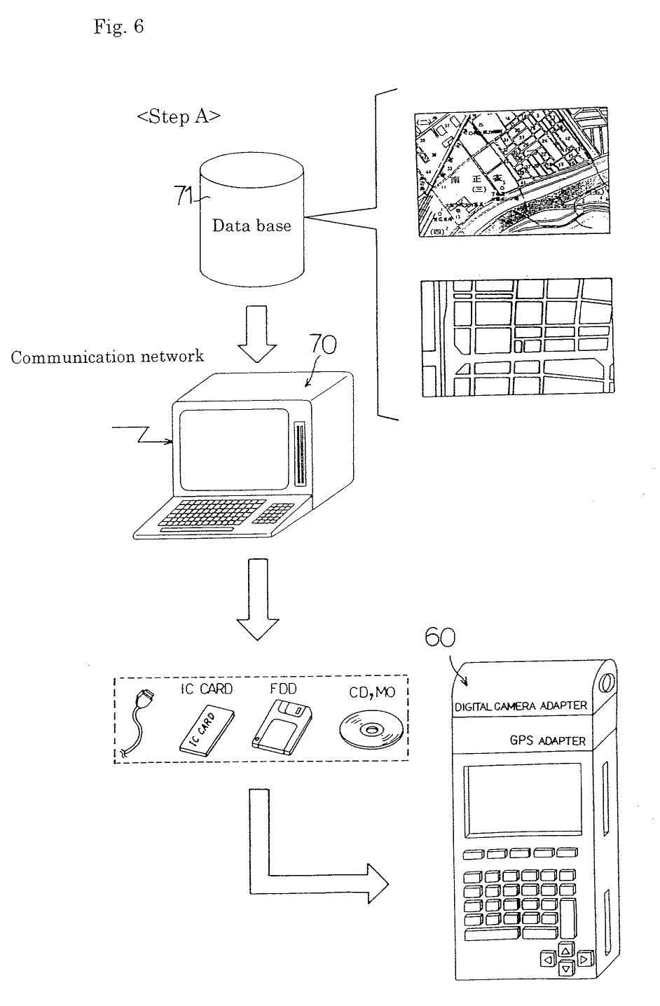

As described above, the portable computer 1 according to the present invention is composed of both hardware and software. Description will now be made of a general process for producing a map stored with the actual photo-image data using such a portable computer, with each process described in detail one after another.

<Step A> (FIG. 6)

Map data covering a wide area including an intended position for photography is transferred to a portable computer 1 from the library of a map data base 71 that is constructed in a computer 70 installed at a fixed base such as an office. A computer 70 is connected to the communication network for making an interchange of data with a mainframe in the head office or computers in the other branches and those in the same profession. Transfer of the map data from the computer 70 to the portable computer 60 may be carried out through portable memory medium or direct connection by cables between the computer 70 to the portable computer 60. An IC card, floppy disk drive, MO, CD-ROM, or DVD may be used as a portable memory medium. In view of the handling facility, a contactless IC card is regarded as the best choice among the above-noted portable memory medium.

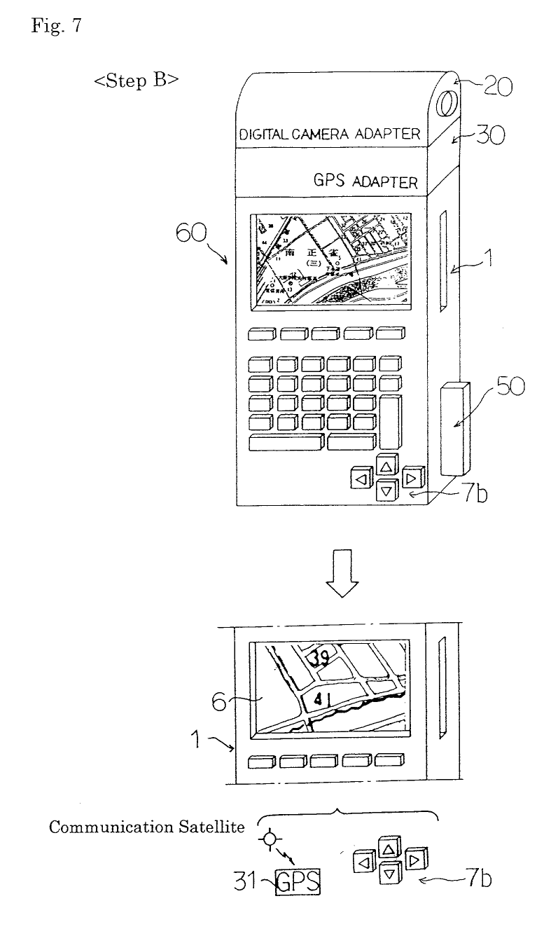

Since no writing is possible into CD-ROMs, entry of duplicated data into this memory medium cannot be done in any form. In this case, the map data base 71 for the computer 70 must be composed of the multiple numbers of CD-ROMs, among which applicable ones are to be selected, so that they may be read out by the CD-ROM drive attached to the portable computer 60. CD-ROM is a big data loader capable of storing a large number of maps. In particular, CD-ROMs carrying general purpose map data which is under current development may also be useful. When using CD-ROMs as the data loader, the portable computer 60 must have a rewritable medium such as the IC cards or floppy disk to send the actual photo-image data and position data back to the computer 70.

<Step B> (FIG. 7)

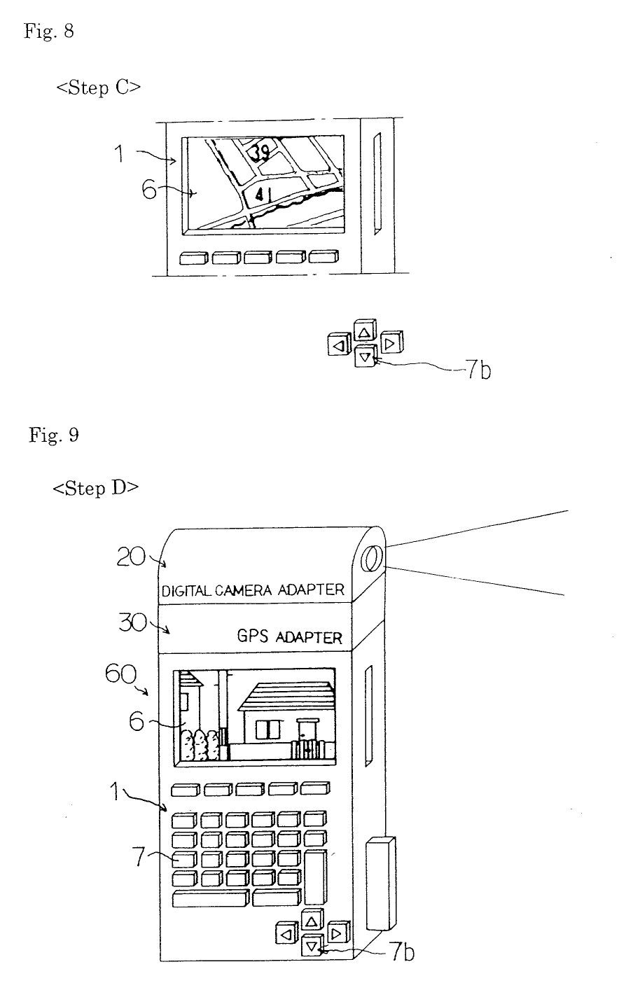

A portable computer 60 with loaded surrounding map data of the surrounding area (wide area map data) including an intended position for photography is brought to the intended position for photography, and a small area map data including the specific positions for photography are selectively displayed on the screen thereof. In order to call out the small area map data, a cursor is scrolled by operating cursor moving keys 7b on the screen where the wide area map data is shown, followed by pressing the execution key, or by directly entering a command with a pen inputting device, or by running a GPS adaptor.

<Step C> (FIG. 8

In this step, the present position as the photographing position and the direction for photography is specified on small area map data shown on the screen display. Such specification is conducted by operating the cursor moving keys 7b or entry of command from the pen inputting device, similar to Step B, while position data X, Y corresponding to the specified point is calculated by a microprocessor. When using a GPS adaptor having a very high precision that is capable of measuring position within 2-3 m tolerance, it is possible to specify the present position without manual operation either for displaying wide area map data or for specifying the position for photography on the small area map data. Furthermore, loading a gyrocompass onto the portable computer will makes it possible to detect the direction for photography automatically.

<Step D> (FIG. 9)

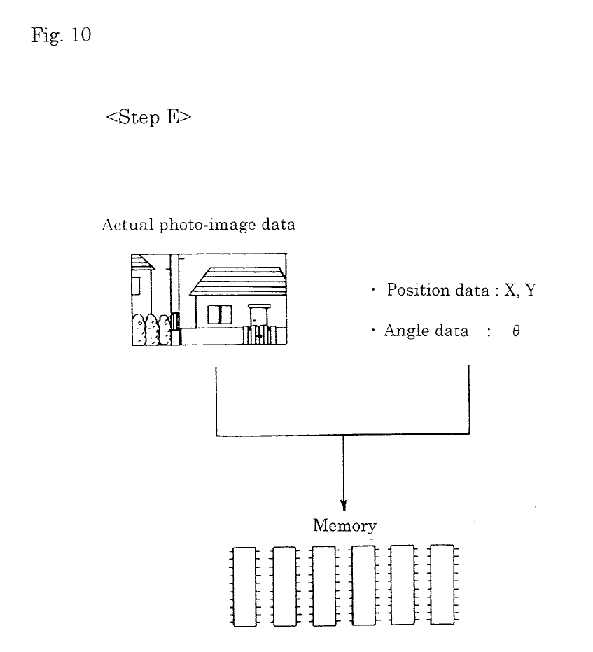

In this step, the setting position of the portable computer 60 is adjusted to capture the object for photography within the visual field of the image capturing unit before a photograph is taken. In the illustration, since the object for photography is a scene on the street, the scene on the street is displayed on the display. Since the image being currently captured by the image capturing unit can be monitored on the display device 6, adjustment for obtaining an optimum image may be carried out by manual operation of specific keys on the keyboard 7, followed by confirming that the image is in the optimum condition before pressing an execution key. There is no need of making image adjustment every time. Under the same conditions and circumstances, a photograph may be taken by leaving the last state of adjustment unchanged.

<Step E> (FIG. 10)

Actual photo-image data transmitted from an image capturing unit via bus to the microprocessor is stored into a memory in association with the above-described position data X, Y and direction for photography. Thus, it is possible to manage the positional relationship between the map data and the actual photo-image data of scenes on the street corresponding to each other.

In the above-described manner, the actual photo-image data on each position where a photograph is taken is stored in association with the position data X, Y and an angle data θ through repeating Steps B to E while moving the position for photography from one after another in succession.

Here is a detailed description of one specific example of photographing. As illustrated in FIG. 11, actual photo-images of the rows of buildings along the street may be captured through photographing scenes on the other side of the street in succession from a photographing position P on one side of the street, followed by the photographing scenes on the one side of the street from the photographing position on the other side of the street. In this way, sequential actual photo-images on both sides of the street can be obtained. Furthermore, in the case of photographing at an intersection, photo-images in four directions are taken from the center of an intersection by turning the position P for photography by 90° each time to thereby obtain the actual photo-images covering a full angle range of 360°.

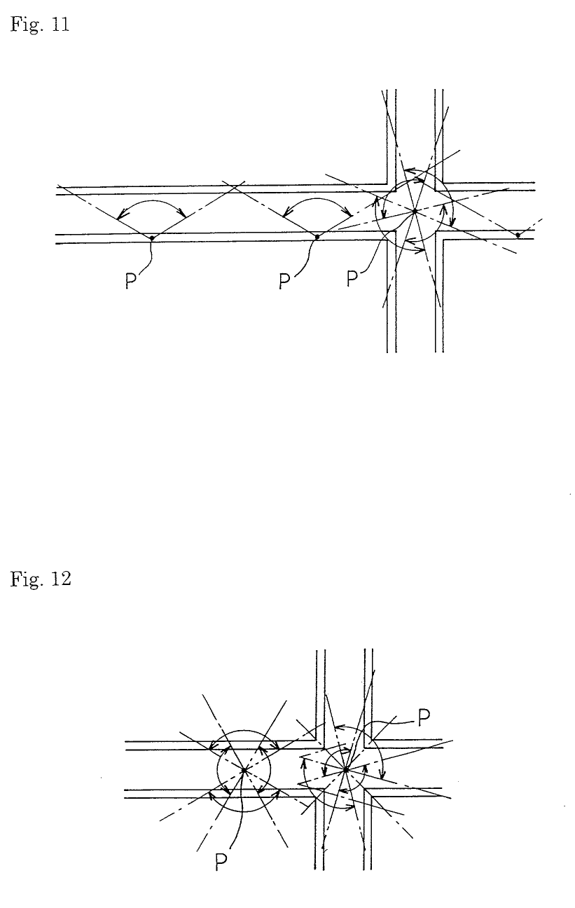

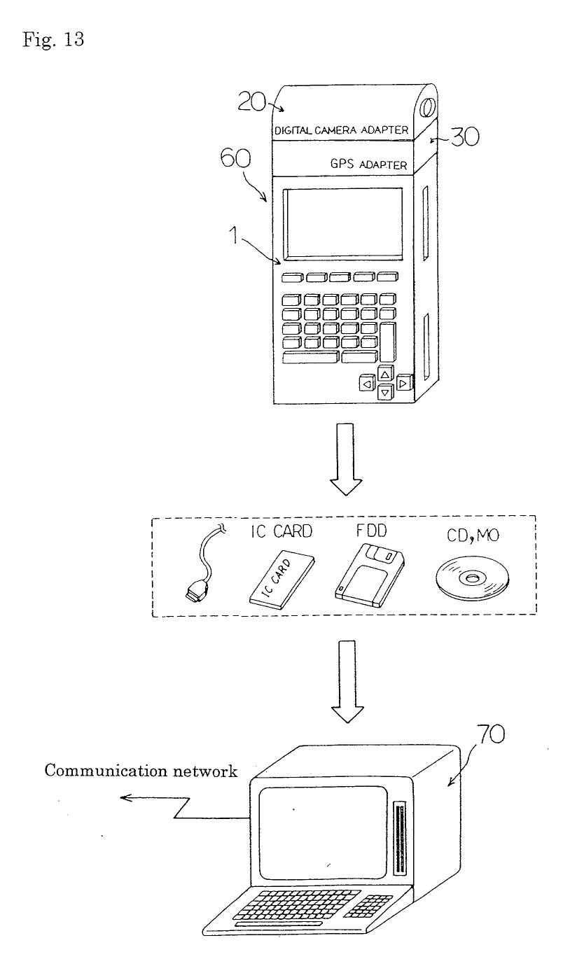

FIG. 12 shows another step of photographing actual photo-images from the center of the street at regular intervals of angles as illustrated on FIG. 12 for capturing scenes on the street. Likewise, a plurality of portable computers 60 may be installed on a roof of an automobile or carriage so as to capture the actual photo-images sequentially over the full angle range of 360°.

<Step F> (FIG. 13)

After having finished photographing on the position, essential data stored in the memory means of the portable computer 1 are to be transferred to the computer 70 in the fixed base. These essential data include the actual photo-image data to be stored in association with position data and photographing directions. Transfer of data from the portable computer 60 to the computer 70 installed in a fixed base may be done in the same step as described in Step A.

Actual photo-image data, position data and photographing direction data thus collected may be loaded into the memory medium such as the CD-ROM, together with a flat map data and control programs for a starting-up, to be used either on a home PC or as the map data for car navigation systems, etc. For the actual photo-image data with overlaps trimmed correctly by the computer 70 or those captured by a wide angle lens may be stored into the memory medium after modifying image distortions.

Next, there will be described an example of using the map stored with actual photo-image data in the memory medium such as the CD-ROM. In this example, the map stored with the actual photo-image data is used on the PCs at home.

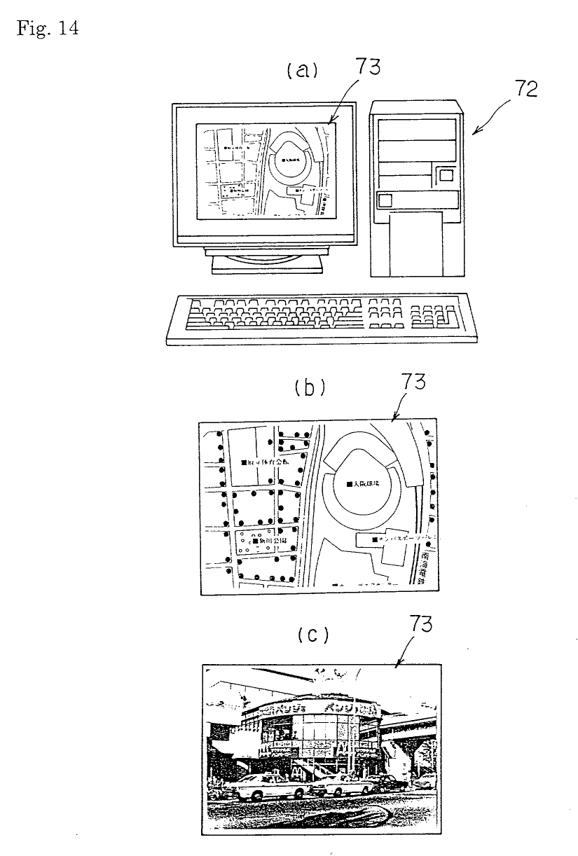

As shown in FIG. 14, a control program for the map stored with actual photo-image data is started on a PC 72 to thereby display a wide area map on a screen 73. As shown in FIG. 14B, the positions where actual photo-images can be seen are marked with a symbol “•”, and by moving a cursor to any one of the desired positions marked with “•” for a click, the actual photo-images will be shown either totally or partitioned as shown in FIG. 14C. It is also possible to magnify any particular portion of the actual photo-images by moving a cursor to the exact position on the screen. Furthermore, by scrolling the screen to move the actual photo-images displayed thereon forward and backward, such an effect is obtained that the actual photo-images sequentially displayed as if moving visual points on the position where the photograph has been taken, or that actual photo-images are moved continuously along the street on the map to give a continuity of actual photo-images on the screen as if actually walking down the street. On the contrary, it is also possible to compose a reverse step whereby the position on the plan map can be detected from the actual photo-images. The actual photo-images of the town may also be displayed on the screen together with the visual information such as business hours and merchandise of the stores both in written text and in photo images.

Here is another example of application for the portable computer with partially modified construction.

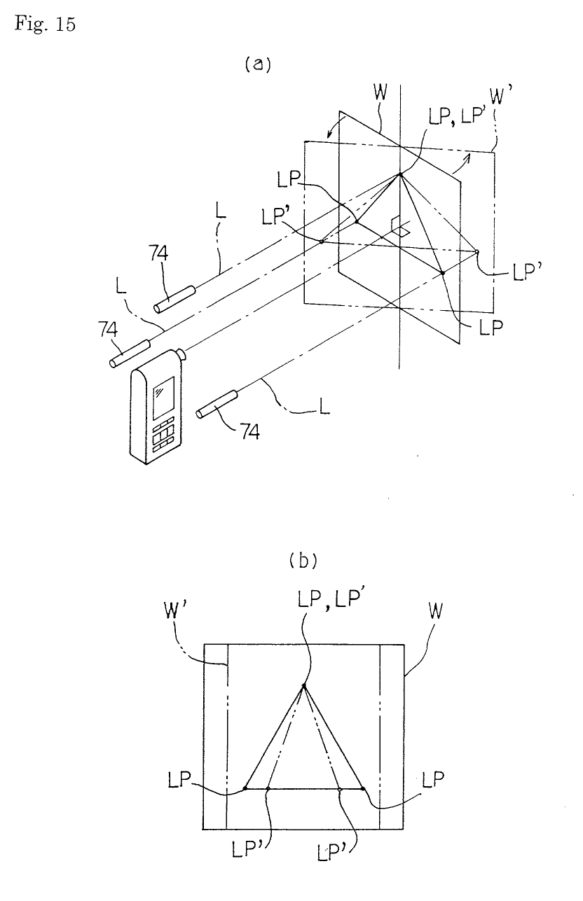

For capturing the actual photo-image data, a portable computer may be provided with three laser light irradiation means 74 which are to be set at each position of a regular triangle apex as shown in FIG. 15, from which a laser light L is to be irradiated substantially parallel to the photographing direction while an object W is being photographed by the portable computer.

In the portable computer with such a construction, when the photographing direction is set, as shown by a solid line in FIG. 15A, perpendicular to the object W for photography, photographing direction must be set perpendicular to the radiation points LP of three laser lights L will be on each of three apexes of the regular triangle as shown in FIG. 15B. However, when the photographing direction is set slanting to the object W′ for photography as shown in FIG. 15A, an irradiation points LP′ from three laser lights L will be on the apexes of triangles other than the regular triangle as shown in diagram (b). By correcting a whole actual photo-image such that the irradiation points LP′ on the actual photo-image reside in the apexes of the regular triangles, it becomes possible to obtain a photo-image looked at to the front of the actual photo-image.

Since each distance among the three laser lights L, i.e., the distance between each one of the irradiation points LP′, is set at the fixed intervals, it is also possible to grasp the size of the object W for photography as the actual photo-image shown on the screen.

Incidentally, three laser lights L may be set to be irradiated to the apex of the regular triangle on a plane perpendicular to the photographing direction, and at the same time the farther away will be the position of as a laser light irradiating means 74 become far from the subject the longer will be the distance between each one of three laser lights L. This makes it possible to set longer distance between each point of projection LP for obtaining more precise actual photo-images while keeping the size of portable computer unchanged.

It is also possible to use more than three laser light irradiating means 74. Further, the laser light having a relatively large round irradiation point is irradiated to the object for photography, and the actual photo-image may be corrected to have a similar round irradiation point on the photographed actual photo-image.

Furthermore, the portable computer is provided with a measuring means for measuring a physical quantity relating to at least one environmental condition selected from temperature, humidity, noise level and illumination at the time of photographing, and such measured data may be stored in association with the actual photo-image.

Therefore, according to the portable computer of the present invention, for example, by taking a photograph of a street scene by a digital camera and by setting an identification data for specifying a photographing related positions by the position specifying identification data setting means, it becomes possible to associate an actual photo-image data with the identification data with each other on the spot where photograph is taken, to thereby facilitate the management of the actual photo-image data. Further, in case of using as the identification data maps, positions on a drawing, residential addresses, phone numbers, or the like, the mutual relevance among the respective actual photo-image data is enhanced, thereby enabling to take out necessary the actual photo-image data with ease based on the identification data, and to remarkably expand the application range of the actual photo-image.

Further, since the portable computer according to the present invention include as the position specifying identification data setting means base data memory means for storing a map or drawing data including at least the photographing related positions and display means for displaying the same, a present position or the like may be grasped based on the map or drawing data displayed on the display means without carrying the map or the like. Still further, the portable computer according to the present invention is provided with an input means for inputting the photographing related positions through the map or drawing data displayed on the display means, and therefore it is possible to specify the photographing related positions on the map or drawing displayed on the display means by operating a cursor of the input means, with a result that the position data on the map or drawing may be used with ease as the identification data.

Furthermore, since the position specifying identification data setting means includes a GPS adaptor for measuring an absolute position by using a communication satellite, the present position may be readily grasped. Also, the photographing position is used as the photographing related position, the data of the present position outputted from the GPS adaptor may be automatically captured as it is as the identification data.

Further, a portable computer according to the present invention is provided with a measuring means for measuring a physical quantity relating to at least one environmental condition selected from temperature, humidity, noise level and illumination at the time of photographing, and measured data outputted from said measuring means are stored in association with the actual photo-image data into said actual photo-image data memory means, thereby being capable of displaying in such a manner that the surrounding circumstances at the position of photographing may be grasped.

Furthermore, since a portable computer according to the present invention includes a laser light irradiating means for irradiating a laser light to an object for photography in substantially parallel to the photograph direction, it is possible to convert the actual phot-image into the frontal view or the side view. Also, since it is possible to constitute so as to able to grasp the actual size of the object for photography, the portable computer of the present invention may be utilized for the inspection of constructions.

According to a data management system of the present invention, when taking the actual photo-images using the digital camera, the actual photo-image data are stored in association with identification data into the actual photo-image memory means, successively, thereby management of the actual photo-image data is facilitated. Further, in case of using as the identification data maps, positions on a drawing, residential addresses, phone numbers, or the like, the mutual relevance among the respective actual photo-image data is enhanced, thereby enabling to take out necessary actual photo-image data with ease based on the identification data, and to remarkably expand the application range of the actual photo-image.

According to a method of producing a map stored with actual photo-image data of the present invention, since the actual photo-image data is stored in association with the position data on the map or the drawing data, the actual photo-image of the object for photography at the specified photographing related positions may be realistically grasped, by specifying the photographing related positions set on the map. Further, if such a map stored with an actual photo-image data is stored into a memory medium such as a CD-ROM, it enables to utilize the map for those in car navigation systems, or as an appendix of a town magazine, etc., for introducing restaurants and play spots, or for recording chronological change of sights on the street for verification.

Further, according to a method of producing a map stored with live photo-image data of the present invention, in case of taking a plurality of actual photo-images so as to overlap the respective adjacent side end portions with each other and subjecting a data processing such as cutting the overlapped portions of the actual photo-images on a main computer, it makes possible to capture a scenes on the street, etc., as the successive photo-image.

Furthermore, according to a method of producing a map stored with actual photo-image data of the present invention, in case of using a digital camera with wide-angle lens as a digital camera, it is possible to substantially compress the actual photo-image data by enlarging the photographing area of one actual photography.

What is claimed is:

1. A portable computer which is connectable directly or through a memory medium to the main computer in a fixed base, comprising:
a digital camera detachably provided for successively taking actual photo-images;
position specifying identification data setting means for setting identification data to specify at least one of photographing related positions consisting of a position of an object for photography taken by said digital camera and a position where photography was taken by said digital camera; and
actual photo-image data memory means for storing the identification data set by said position specifying identification data setting means in association with actual photo-image data outputted from the digital camera.

2. A portable computer as claimed in claim 1, wherein said position specifying identification data setting means comprises:
base data memory means for storing a map or drawing data including at least photographing related positions; and
display means for displaying said data.

3. A portable computer as claimed in claim 2, wherein said position specifying identification data setting means further includes input means for inputting photographing related positions on the map or drawing displayed on the display means.

4. A portable computer as claimed in claim 2 or 3, wherein said position specifying identification data setting means further includes a GPS adaptor for measuring an absolute position by using a communication satellite.

5. A portable computer as claimed in any one of claims 1 to 4, wherein said position specifying identification data setting means sets as identification data an address for storing actual photo-image data in the memory of the main computer.

6. A portable computer as claimed in any one of claims 1 to 5, including measuring means for measuring a physical quantity relating to at least one environmental condition selected from temperature, humidity, noise level and illumination at the time of photographing, wherein measured data outputted from said measuring means are stored in association with the actual photo-image data into said actual photo-image data memory means.

7. A portable computer as claimed in any one of claims 1 to 6, including laser light irradiating means for irradiating a laser light to an object for photography.

8. A data management system for managing a storing of actual photo-image data outputted from a digital camera when taking the actual photo-images using the digital camera, in association with identification data for specifying photographing related positions into actual photo-image memory means, successively.

9. A method of producing a map stored with actual photo-image data, comprising the steps of:
transporting a portable computer as claimed in any one of claims 1 to 7 to the position where a photography is taken;
taking actual photo-images which can be viewed from the position where photographs are taken using a digital camera detachably provided with the portable computer; and
storing the actual photo-image data outputted from the digital camera in association with position data on drawing data as identification data for specifying photographing related positions.

10. A method of producing a map stored with live photo-image data as claimed in claim 9, further comprising the steps of:
taking a plurality of actual photo-images using the digital camera so as to overlap the respective adjacent side end portions with each other; and
subjecting a data processing such as cutting the overlapped portions of the actual photo-images on a main computer after transferring the actual photo-image data directly or via a recording medium from the portable computer to the main computer.

11. A method of producing a map stored with actual photo-image data as claimed in claim 9 or 10, further comprising:
using a digital camera with wide-angle lens as a digital camera; and
a step of subjecting a correction processing to the wide-angle actual photo-image data outputted from the digital camera for correcting distortions of photo-image due to the wide-angle lens.
